(19) United States
(12) Patent Application Publication
(10) Pub. No.: US 2020/0028552 A1
(43) Pub. Date: Jan. 23, 2020

(54) EXPLOITING RECEIVER ANTENNA CORRELATION IN SPATIAL COMPRESSION BASED CSI FEEDBACK SCHEME

(71) Applicant: Nokia Technologies Oy, Espoo (FI)

(72) Inventors: Rana Ahmed Salem, Munich (DE); Eugene Visotsky, Buffalo Grove, IL (US); Frederick Vook, Schaumburg, IL (US); Bill Hillery, Lafayette, IN (US)

(73) Assignee: Nokia Technologies Oy

(21) Appl. No.: 16/038,675

(22) Filed: Jul. 18, 2018

(51) Int. Cl. H04B 7/0456; H04B 7/06; H04B 7/0452

(52) U.S. Cl. CPC H04B 7/0469; H04B 7/0452; H04B 7/0634; H04B 7/0626

(57) ABSTRACT

A method includes determining a number of polarizations. The method also includes determining a number of receive antennas that have a same polarization, determining a total number of receive antennas based on the number of polarizations and the number of receive antennas that have the same polarization; and applying singular value decomposition precoding on all the receive antennas with the same polarization.

### TECHNICAL FIELD

The teachings in accordance with the exemplary embodiments of this invention relate generally to Radio Standards including physical layer (PHY), Medium access control (MAC), Radio Link Control (RLC), Radio Resource Control (RRC), etc., and particularly, to radio physical layer design. More specifically, teachings in accordance with the exemplary embodiments relate to signalling formats between the user equipment (UE) and base stations.

### BACKGROUND

In FDD systems (or some TDD systems, for example, those without proper calibration), the UE has to send back the DL channel information to the gNB due to the absence of channel reciprocity. The gNB may use this information to build DL precoding matrices. In LTE and NR phase I, the UE sends back one or more indices called Precoding Matrix Indicator(s) known as PMI, which point to one or more codeword(s) in a predetermined codebook known at UE and gNB sides. The predetermined codebook is based on DFT precoding. For NR phase II, a more accurate description of the channel at the gNB is required for improved multi user (MU)-MIMO performance and more advanced schemes such as non-linear precoding, coordinated multi-point transmission (CoMP) or Interference Alignment (IFA).

In one proposal, as described by Samsung, CATT (Center for Advanced Technology in Communication), ZTE Corporation, Nokia, RP−172767 titled “Motivation for new WI: Enhancements on MIMO for NR” in the GPP TSG RAN Meeting #78, the UE uses singular value decomposition (SVD) precoding to compress the channel frequency response (CFR) available at the UE. This approach may exploit the spatial and frequency correlation properties. For one receive antenna index, the CFR can be determined as a function of CFR complex coefficient between transmit antenna port (beam), receive antenna and frequency band index.

Certain abbreviations that may be found in the description and/or in the Figures are herewith defined as follows:

CFR channel frequency response

CIR channel impulse response

COMP Coordinated multi-point

CSI Channel State Information

DL Down link

DMRS Demodulation Reference Signal

FDD frequency division duplex

gNB 5G Enhanced Node B (Base station)

GoB grid of beams

IFA Interference alignment

LOS Line of sight

LTE long term evolution

MAC Medium access control

MEC multi-access edge computing

MIMO multiple input multiple output

mMIMO Massive MIMO

MME mobility management entity

MSE mean square error

Mu-MIMO Multi-user, multiple-input, multiple-output

Multi-TRP multi-transmit receive point

NCE network control element

NLOS Non line of sight

NR New radio

N/W Network

PCA Principal Component Analysis

PMI precoder matrix indicator

SVD Singular Value Decomposition

TDD time division duplex

UE User Equipment

5G Fifth generation mobile communication system

### BRIEF SUMMARY

The following summary includes examples and is merely intended to be exemplary. The summary is not intended to limit the scope of the claims.

In accordance with one aspect, an example method comprises determining a number of polarizations, determining a number of receive antennas that have a same polarization, determining a total number of receive antennas based on the number of polarizations and the number of receive antennas that have the same polarization; and applying singular value decomposition precoding on all the receive antennas with the same polarization.

In accordance with another aspect, an example apparatus comprises means for determining a number of polarizations, means for determining a number of receive antennas that have a same polarization, means for determining a total number of receive antennas based on the number of polarizations and the number of receive antennas that have the same polarization; and means for applying singular value decomposition precoding on all the receive antennas with the same polarization.

In accordance with another aspect, an example apparatus comprises at least one processor; and at least one non-transitory memory including computer program code, the at least one memory and the computer program code may be configured to, with the at least one processor, cause the apparatus to: determine a number of polarizations, determine a number of receive antennas that have a same polarization, determine a total number of receive antennas based on the number of polarizations and the number of receive antennas that have the same polarization; and apply singular value decomposition precoding on all the receive antennas with the same polarization.

In accordance with another aspect, an example apparatus comprises a non-transitory program storage device readable by a machine, tangibly embodying a program of instructions executable by the machine for performing operations, the operations comprising: determining a number of polarizations, determining a number of receive antennas that have a same polarization, determining a total number of receive antennas based on the number of polarizations and the number of receive antennas that have the same polarization; and applying singular value decomposition precoding on all the receive antennas with the same polarization.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 is a block diagram of one possible and non-limiting example system in which the example embodiments may be practiced;

FIG. 2 shows an example illustration of signals received by elements in a receiver antenna array;

FIG. 3 shows an example illustration of a geometric mean of user throughput;

FIG. 4 shows an example illustration of a user edge spectral efficiency vs sector spectral efficiency plot;

FIG. 5 shows an example illustration of communication between a base station and a user terminal; and

FIG. 6 shows a method in accordance with example embodiments which may be performed by an apparatus.

### DETAILED DESCRIPTION

In the example embodiments as described herein a method and apparatus that provides multi-beam downlink channel control procedures.

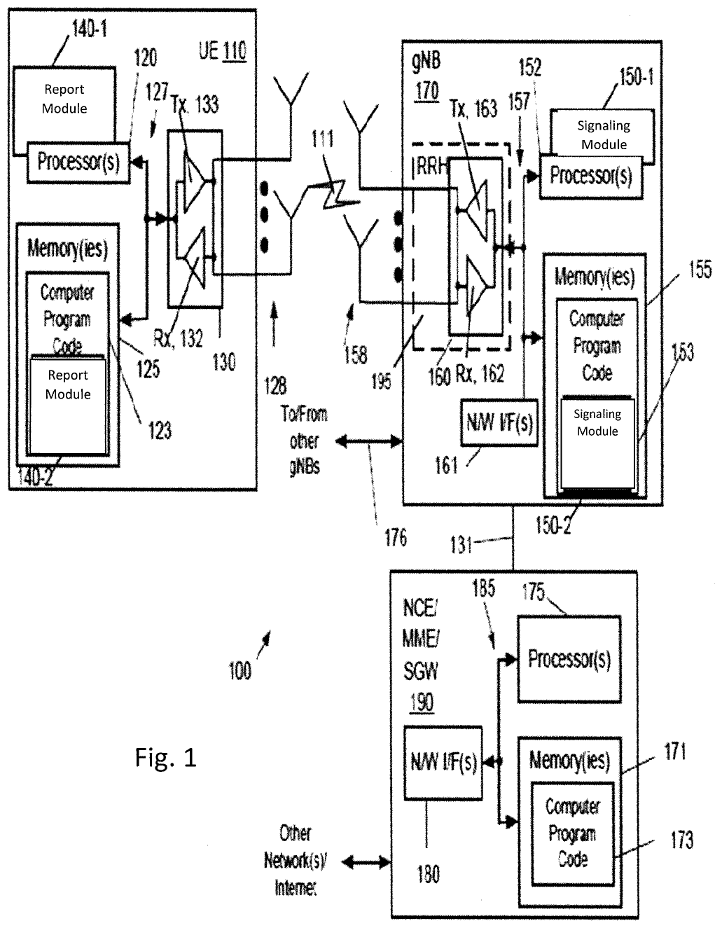

Turning to FIG. 1, this figure shows a block diagram of one possible and non-limiting example system in which the example embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a report module 140, comprising one of or both parts 140-1 and/or 140-2, which may be implemented in a number of ways. The report module 140 may be implemented in hardware as report module 140-1, such as being implemented as part of the one or more processors 120. The report module 140-1 may be implemented also as an integrated circuit or through other hardware such as a programmable gate array. In another example, the report module 140 may be implemented as report module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with eNB 170 via a wireless link 111.

The gNB (NR/5G Node B but possibly an evolved NodeB) 170 is a base station (e.g., for LTE, long term evolution, or for NR, New Radio) that provides access by wireless devices such as the UE 110 to the wireless network 100. The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The gNB 170 includes a signaling module 150, comprising one of or both parts 150-1 and/or 150-2, which may be implemented in a number of ways. The signaling module 150 may be implemented in hardware as signaling module 150-1, such as being implemented as part of the one or more processors 152. The signaling module 150-1 may be implemented also as an integrated circuit or through other hardware such as a programmable gate array. In another example, the signaling module 150 may be implemented as signaling module 150-2, which is implemented as computer program code 153 and is executed by the one or more processors 152. For instance, the one or more memories 155 and the computer program code 153 are configured to, with the one or more processors 152, cause the gNB 170 to perform one or more of the operations as described herein. The one or more network interfaces 161 communicate over a network such as via the links 176 and 131. Two or more gNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the gNB 170 being physically in a different location from the RRH, and the one or more buses 157 could be implemented in part as fiber optic cable to connect the other elements of the gNB 170 to the RRH 195.

It is noted that description herein indicates that “cells” perform functions, but it should be clear that the gNB that forms the cell will perform the functions. The cell makes up part of a gNB. That is, there can be multiple cells per gNB. Each cell may contain one or multiple transmission and receiving points (TRPs).

The wireless network 100 may include a network control element (NCE) 190 that may include MME (Mobility Management Entity)/SGW (Serving Gateway) functionality, and which provides connectivity with a further network, such as a telephone network and/or a data communications network (e.g., the Internet). The gNB 170 is coupled via a link 131 to the NCE 190. The link 131 may be implemented as, for example, an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, gNB 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Embodiments herein may be implemented in software (executed by one or more processors), hardware (e.g., an application specific integrated circuit), or a combination of software and hardware. In an example of an embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium or other device that may be any media or means that can contain or store the instructions for use by or in connection with an instruction execution system, apparatus, or device, such as a computer.

The current architecture in LTE networks is fully distributed in the radio and fully centralized in the core network. The low latency requires bringing the content close to the radio which leads to local break out and multi-access edge computing (MEC). 5G may use edge cloud and local cloud architecture. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services and augmented reality. In radio communications, using edge cloud may mean node operations to be carried out, at least partly, in a server, host or node operationally coupled to a remote radio head or base station comprising radio parts. It is also possible that node operations will be distributed among a plurality of servers, nodes or hosts. It should also be understood that the distribution of labor between core network operations and base station operations may differ from that of the LTE or even be non-existent. Some other technology advancements probably to be used are Software-Defined Networking (SDN), Big Data, and all-IP, which may change the way networks are being constructed and managed.

Having thus introduced one suitable but non-limiting technical context for the practice of the example embodiments of this invention, the example embodiments will now be described with greater specificity.

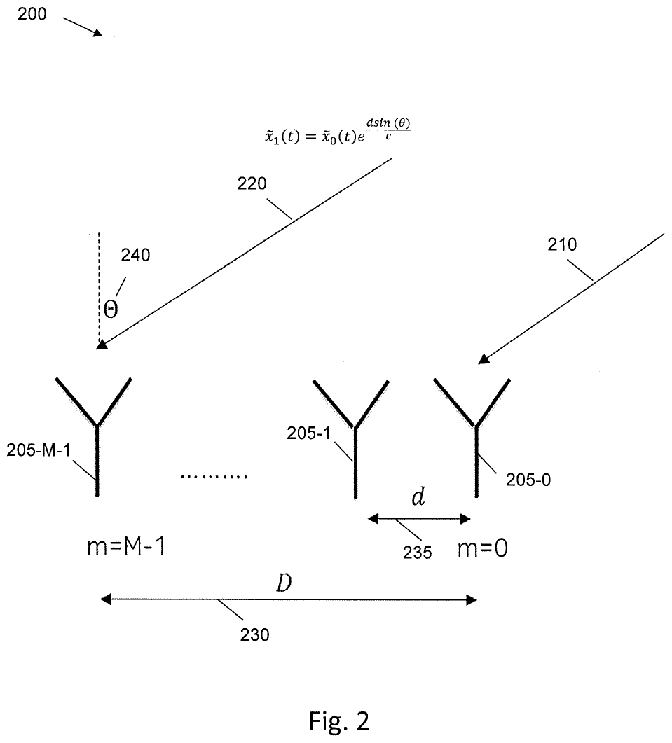

FIG. 2 illustrates signals received by elements in a receiver antenna array 200. As shown in FIG. 2, an example of one dominant path at one time instant t, in this instance the signal 210 received by the first element m=0 205-0 in an antenna array of elements m 205-0 to 205-M-1 that receive signals (210 and 220) at a receive angle θ 240 with an inter antenna spacing distance d 235 between individual antennas and a maximum antenna aperture D 230, a maximum total distance in one dimension (across the entire antenna array).

According to a baseline implementation, the UE 110 may use singular value decomposition (SVD) precoding to compress the channel frequency response (CFR) available at the UE 110, for one receive antenna index n, the CFR may be written as:

$${H}_{M \times {B}_{s}}^{n} = [ \begin{matrix}{c}_{n} ( 1 , 1 ) & {c}_{n} ( 1 , {B}_{s} ) \\ ⋮ & ⋮ \\ {c}_{n} ( M , 1 ) & {c}_{n} ( M , {B}_{s} )\end{matrix} ] = {U}_{M \times d} {E}_{d \times d} {H}_{d \times {B}_{s}}^{H} . \qquad Eqn ( 1 )$$

Where cₙ(m,bₛ) is the CFR complex coefficient between transmit antenna port (beam) m, receive antenna n and frequency band index bₛ. M is the number of transmit antenna ports and Bₛ is the number of subbands. U is the matrix containing the spatial singular vectors, V is the matrix containing the frequency singular vectors and Σ is the diagonal matrix containing the singular values. Owing to the compression behavior (for example, the UE 110 using SVD precoding to compress the CFR available at the UE), mentioned earlier, the CFR may be compressed as:

H_{M×B}_{ₛ}^{d}=U_{M×d}Σ_{d×d}V_{d×B}_{ₛ}^{H} Eqn (2).

Every short term update, the UE 110 may feedback the d most significant singular vectors back to the base station (for example gNB 170). Therefore instead of sending back M.Bₛ complex coefficients, the UE 110 may be required to feedback (M+Bₛ)×d complex coefficients. For a UE 110 with N receive antennas, the feedback overhead is equal to:

N×d×(M+Bₛ)×(Nₐₘₚ+Nₚₕₐₛₑ) Eqn (3).

Where each of Nₐₘₚ and Nₚₕₐₛₑ is a number of bits assigned for encoding the amplitude and phase components, respectively, of every coefficient.

As shown in Eqn (3), the feedback overhead increases linearly with the product of the number of receive antennas and number of antenna ports. In some systems, one UE 110 may have multiple antennas (for example, in NR, one UE 110 may have up to 8 receive antennas) which in such case of SVD precoding feedback scheme may lead to a huge feedback overhead which cannot be supported (or accepted/tolerated).

The example embodiments exploit (for example, may be based on) the correlation between the channels observed with receiver antennas having the same polarization.

Referring now to FIG. 2, for one dominant path at one time instant t, let the signal received by the first element m=0 be x₀(t)=α(t)cos(ωt+s(t)+β). Assuming that there is only one strong path with incoming angle theta, the rest of the paths may be ignored and the strong path may be determined as one dominant path. Where the angular frequency ω=2πf_{c}, f_{c} is the carrier frequency, β is some random phase, α(t) is the amplitude of the signal s(t) is the information carrying component.

The signal received at m=1 is x₁(t)=x₀(t−τ) (Eqn. 4). Where τ=_{c}^{d sin(θ)}. Wherein c is the speed of light. Tau (τ) is the time delay by which the signal arrives between two neighboring antennas.

Therefore, the signal received at m=1: x₁(t)=α(t−τ)cos(ω(t−τ)+s(t−τ)+β) (Eqn. 5)

For the case of not so large bandwidth, for example,

$$τ ≪ \frac{1}{BW} , {x}_{1} ( t ) \approx a ( t ) cos ( ω t - ω τ + s ( t ) + β ) . \qquad ( Eqn . 6 )$$

Hence, the complex envelope may be determined as:

$${\tilde{x}}_{1} ( t ) = {\tilde{x}}_{0} ( t ) {e}^{\frac{dsin ( θ )}{c}} . \qquad ( Eqn . 4 ) .$$

According to an example embodiment in which signal 220 is x_1, Eqn (4) describes the complex envelope of signal 220.

Therefore, if the angular spread at the UE 110 side is not very high, there will be strong correlation on the amplitude of the received signals on receive antennas 205 which have the same polarization. The angular spread may be determined based on the UE 110 position, etc. A predetermined threshold may be used to determine instances in which the angular spread corresponds to a strong correlation. In frequency domain, this may lead to a correlation between the received signals on receive antennas 205 which have the same polarization.

Equation 7.3-22 of the 3GPP channel model description as described by 3GPP, “3GPP TR 36.873 V12.4.0 3rd Generation Partnership Project; Technical Specification Group Radio Access Network; Study on 3D channel model for LTE (Release 12)”, states the following:

$${H}_{u , s , n} ( t ) = \sqrt{{P}_{n} / M} {\sum }_{m = 1}^{M} {[ \begin{matrix}{F}_{rx , u , θ} ( {θ}_{n , m , ZOA} , {φ}_{n , m , AOA} ) \\ {F}_{rx , u , φ} ( {θ}_{n , m , ZOA} , {φ}_{n , m , AOA} )\end{matrix} ]}^{T} [ \begin{matrix}exp ( j {Φ}_{n , m}^{θθ} ) & \sqrt{{κ}_{n , m}^{- 1}} exp ( j {Φ}_{n , m}^{θφ} ) \\ \sqrt{{κ}_{n , m}^{- 1}} exp ( j {Φ}_{n , m}^{φθ} ) & exp ( j {Φ}_{n , m}^{φφ} )\end{matrix} ] [ \begin{matrix}{F}_{tx , s , θ} ( {θ}_{n , m , ZOD} , {φ}_{n , m , AOD} ) \\ {F}_{tx , s , φ} ( {θ}_{n , m , ZOD} , {φ}_{n , m , AOD} )\end{matrix} ] exp ( j 2 {πλ}_{0}^{- 1} ( {\hat{r}}_{rx , n , m}^{T} \cdot {\overline{d}}_{rx , u} ) ) exp ( j 2 {πλ}_{0}^{- 1} ( {\hat{r}}_{tx , n , m}^{T} \cdot {\overline{d}}_{tx , s} ) ) exp ( j 2 π {v}_{n , m} t ) . \qquad ( Eqn . 7 )$$

In instances in which the UE 110 has omni directional antennas, the field patterns F_{rx,u,θ} and F_{rx,u,ϕ} is equal to 1. This means the only part dependent on the receive antenna index is the exponential term exp(j2πλ⁻¹(\hat{r}_{rx,n,m}^{T}d̅_{rx,u})) describing the array manifold.

For a LOS user, the channel coefficient, H, may be computed as equation 7.3-27 of the 3GPP channel model description.

$${H}_{u , s , n} ( t ) = \sqrt{\frac{1}{{K}_{R} + 1}} {H}_{u , s , n}^{′} ( t ) + δ ( n - 1 ) {\sqrt{\frac{{K}_{R}}{{K}_{R} + 1}} [ \begin{matrix}{F}_{rx , u , θ} ( {θ}_{LOS , ZOA} , {φ}_{LOS , AOA} ) \\ {F}_{rx , u , φ} ( {θ}_{LOS , ZOA} , {φ}_{LOS , AOA} )\end{matrix} ]}^{T} [ \begin{matrix}exp ( j {Φ}_{LOS} ) & 0 \\ 0 & - exp ( j {Φ}_{LOS} )\end{matrix} ] [ \begin{matrix}{F}_{tx , s , θ} ( {θ}_{LOS , ZOD} , {φ}_{LOS , AOD} ) \\ {F}_{tx , s , φ} ( {θ}_{LOS , ZOD} , {φ}_{LOS , AOD} )\end{matrix} ] \cdot exp ( j 2 {πλ}_{0}^{- 1} ( {\hat{r}}_{rx , LOS}^{T} \cdot {\overline{d}}_{rx , u} ) ) \cdot exp ( j 2 {πλ}_{0}^{- 1} ( {\hat{r}}_{tx , LOS}^{T} \cdot {\overline{d}}_{tx , s} ) ) \cdot exp ( j 2 π {v}_{LOS} t ) . \qquad Eqn . ( 8 )$$

In this instance, it is clear that there is one dominant path (for example, for high values of K_{R}). Two receive antennas 205 sharing the same polarization may therefore see very close amplitude for that path and at the same time instant t. In instances of LOS users, a strong correlation may be determined. Further, the example embodiments may also detect some degree of amplitude correlation for NLOS users.

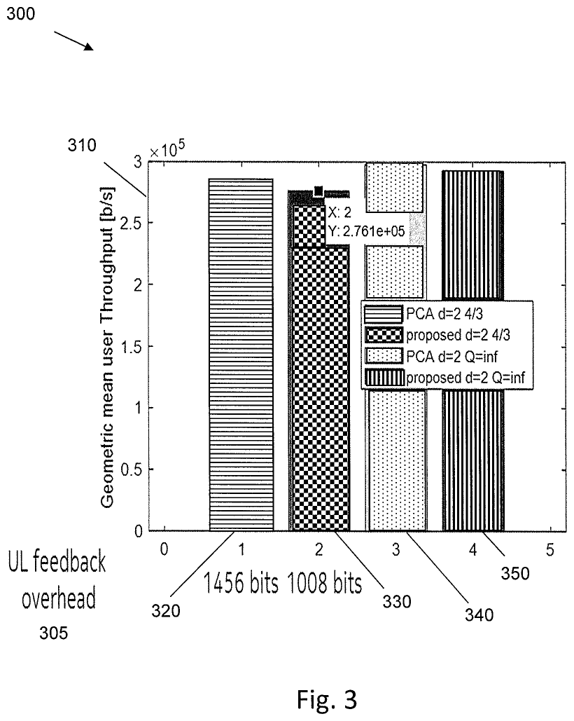

Referring to FIG. 3, there is shown an example illustration of geometric mean of user throughput 300. As shown in FIG. 3, the geometric mean of user throughput may be measured in bits per second 310 with regard to UL feedback overhead 305 for different PCA and proposed d.

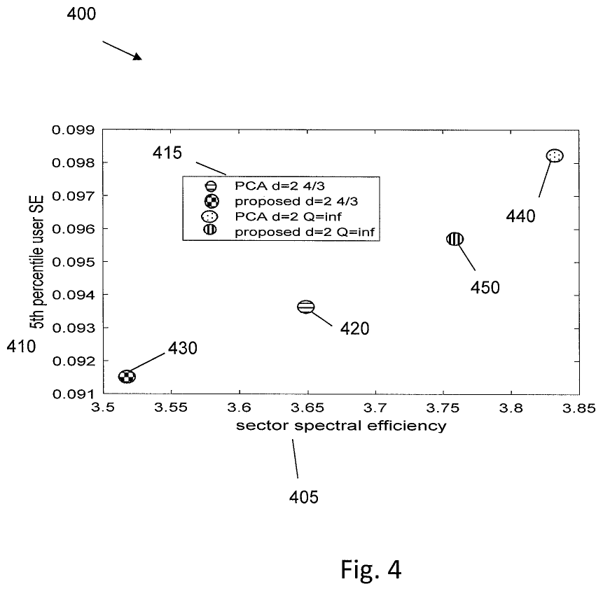

FIGS. 3 and 4 provide example illustrations of the result of the result of application of the example embodiments in which proposed refers to the results of application of example embodiments and Q is the resolution of the quantization.

As shown in FIG. 3, each of the UL feedback overhead 305 for PCA d=2 4/3 (320), proposed d=2 4/3 (330), PCA d=2 Q=inf (340), proposed d=2 Q=inf (350), has a corresponding geometric mean user throughput in bits/second 310. 4/3: refers to the quantization resolution per coefficient: 4 bits for the phase component and 3 bits for the amplitude part. The values on the Y axis are the UE 110 throughput. Q=inf refers to infinite resolution, i.e. , no quantization at all.

As shown in FIG. 3, with Nₐₘₚ=3 bits,Nₚₕₐₛₑ=4 bits (4/3), the baseline approach, as described with respect to Eqns. 1-3, requires approximately 1456 bits for feedback overhead, while the example embodiments require reduced overhead, for example, approximately 1008 bits.

The example embodiments may exploit the correlation on the same polarization receive antennas 205 as follows.

The example embodiments may use an assumption that N=p×Nᵣ, where P is the number of polarizations, in this case P=2, and Nᵣ is the number of receive antennas with the same polarization.

The example embodiments may, instead of applying SVD precoding on each receive antenna separately, as in the baseline method described with respect to the background and FIG. 2 (Eqns 1-3), apply SVD precoding on all Nᵣ receive antennas with the same polarization.

The example embodiments may exploit the correlation among receive antennas with the same polarization (for example, as shown in Eqn 5) to provide a better compression of the CSI and consequently save UL feedback overhead. The example embodiments may apply the following equation for each polarization p=0 . . . P−1

$${\tilde{H}}_{M \times {B}_{s} \cdot {N}_{T}}^{p} = {[ \begin{matrix}{c}_{1 + {pN}_{r}} ( 1 , 1 ) & & {c}_{{N}_{r} + {pN}_{r}} ( 1 , 1 ) & & {c}_{1 + {pN}_{r}} ( 1 , {B}_{s} ) & & {c}_{{N}_{r} + {pN}_{r}} ( 1 , {B}_{s} ) \\ ⋮ & … & & … & & … & ⋮ \\ {c}_{1 + {pN}_{r}} ( M , 1 ) & & {c}_{{N}_{r} + {pN}_{r}} ( M , 1 ) & & {c}_{1 + {pN}_{r}} ( M , {B}_{s} ) & & {c}_{{N}_{r} + {pN}_{r}} ( M , {B}_{s} )\end{matrix} ]}_{{B}_{s} \times M \cdot {N}_{r}} = {\tilde{U}}_{M \times d} {\tilde{Σ}}_{d \times d} {\tilde{V}}_{d \times {B}_{s} \cdot {N}_{r}}^{H} . \qquad Eqn . ( 9 )$$

For each polarization, this finds the channel matrix for all the Nᵣ receive antennas at the same time. With this scheme, in an example embodiment, SVD precoding is used to exploit the spatial, frequency and same-polarization correlation simultaneously. The feedback overhead required is P×d×(M+Nᵣ×Bₛ)×(Nₐₘₚ+Nₚₕₐₛₑ).

The ratio between the newly required feedback overhead using the example embodiments and the baseline is.

$$\frac{M + {N}_{R} {B}_{s}}{{N}_{R} \cdot M + {N}_{R} {B}_{s}}$$

Simulation results on a system with M=16 antenna ports, Bₛ=10 frequency bands, UMi channel [2], each UE 110 has N_{R}=2 cross polarized (Xpol) Antennas (for example, N=4), the example embodiments assume a bandwidth of 10 MHz with 50 physical resource blocks (PRBs), at a carrier frequency of 2 GHz. The example embodiments assume a channel frequency oversampling factor of 12, for example, assuming one pilot subcarrier per PRB. MU-MIMO scheme is carried out, where all UEs 110 are spatially multiplexed on the same time-frequency resources. Up to 2 layers may be transmitted per UE 110. The example embodiments assume a feedback periodicity of 10 ms and for SVD precoding may use d=2 singular vectors.

FIG. 4 is an illustration of user edge spectral efficiency vs sector spectral efficiency 400. As shown in FIG. 4, the 5^{th} percentile user spectral efficiency (SE) 410 is plotted against the sector spectral efficiency 405 for each of the PCA d=2 4/3 (420), proposed d=2 4/3 (430), PCA d=2 Q=inf (440), proposed d=2 Q=inf (450), as shown in table/key 415.

As shown in FIG. 4, with Nₐₘₚ=3 bits,Nₚₕₐₛₑ=4 bits, the baseline approach (SVD precoding on each antenna separately) requires approximately 1456 bits for feedback overhead, while the example embodiments requires approximately 1008 bits.

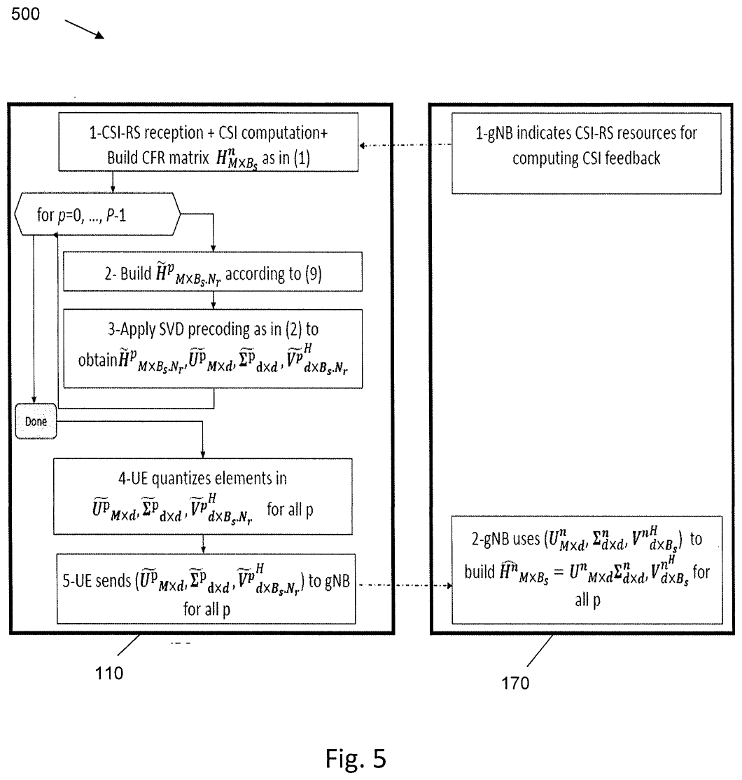

FIG. 5 provides an example illustration of communication between a gNB 170 and UE 110 implementing the example embodiments.

As shown in FIG. 5, the gNB 170 indicates (1) (first step of gNB 170 procedure) CSI-RS resources for computing CSI feedback to the UE 110.

UE 110 (1) (first step of UE 110 procedure) performs CSI-RS reception and CSI computation and builds CFR matrix H_{M×R}_{ₛ}ⁿ as in Eqn (1).

For p=0, . . . , P−1, at (2), UE 110 may build \tilde{H}^{p}_{M×B}_{ₛ}_{.N}_{ᵣ} according to Eqn (9).

At (3), UE 110 may apply SVD precoding as in Eqn (2) to obtain [symbol] _{M×B}_{ₛ}_{.N}_{ᵣ}, [symbol] _{M×d}, [symbol] _{d×d}, [symbol] _{d×B}_{ₛ}_{.N}_{ᵣ}^{H}.

At (4) UE 110 may quantize elements in [symbol] _{M×d}, [symbol] _{d×d}, [symbol] _{d×B}_{ₛ}.Nᵣ^{H} for all p.

At (5) UE 110 may send ( [symbol] _{M×d}, [symbol] _{d×d}, [symbol] _{d×B}_{ₛ}_{.N}_{ᵣ}^{H}) to gNB 170 for all p.

gNB 170, at (2), may use (U_{M×d}ⁿ, Σ_{d×d}ⁿ, Vⁿ^{^{H}}_{d×B}_{ₛ}) to build [symbol] _{M×B}_{ₛ}=Uⁿ_{M×d}Σ_{d×d}ⁿ,V_{d×B}_{ₛ}ⁿ^{^{H}} for all p.

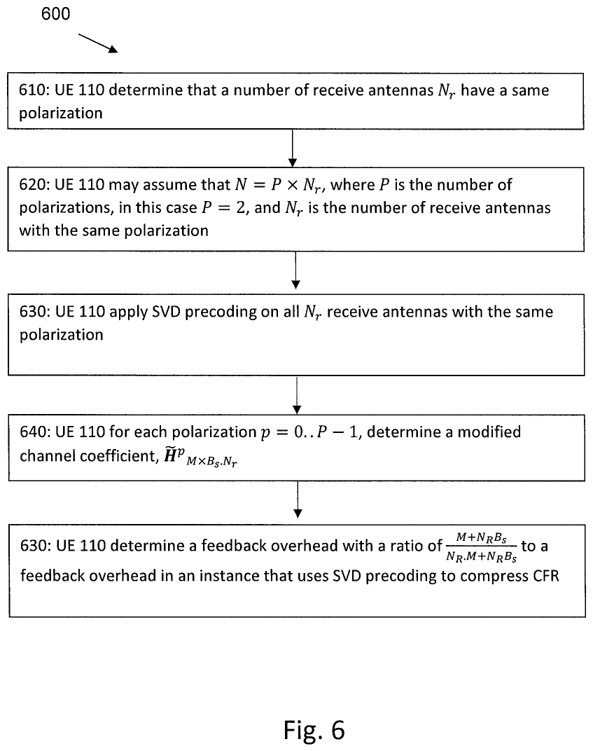

FIG. 6 is an example flow diagram 500 illustrating a method in accordance with example embodiments which may be performed by an apparatus.

At block 610, UE 110 may determine that a number of receive antennas Nᵣ have a same polarization.

At block 620, UE 110 may assume that N=p×Nᵣ, where p is the number of polarizations, in this case p=2, and Nᵣ is the number of receive antennas with the same polarization. N, P and Nr are related to the UE antenna structure. This is independent of the used feedback scheme. Nr is the number of receive antennas per polarization. In other words, no of receive antennas per polarization is the same for all polarizations.

At block 630, UE 110 may apply SVD precoding on all Nᵣ receive antennas with the same polarization. This may be defined as a batch precoding process (or some other group precoding) as distinguished from precoding on each receive antenna separately.

At block 640, UE 110 may, for each polarization p−0 . . . P−1, determine a modified channel coefficient, \tilde{H}^{p}_{N×B}_{ₛ}_{.N}_{ᵣ} as a product of the modified matrix containing the spatial singular vectors, the modified matrix containing the frequency singular vectors and the modified diagonal matrix containing the singular values.

At block 650, UE 110 may determine a feedback overhead with a ratio of

$$\frac{M + {N}_{R} {B}_{s}}{{N}_{R} \cdot M + {N}_{R} {B}_{s}}$$

to a feedback overhead in an instance that uses singular value decomposition (SVD) precoding to compress the channel frequency response (CFR) available at the UE 110 (such as described with respect to Eqn. 3, herein above).

Without in any way limiting the scope, interpretation, or application of the claims appearing below, a technical effect of one or more of the example embodiments disclosed herein is that CSI compression is implemented before CSI feedback so as not to waste unnecessary overhead on the UL. Another technical effect, as shown by simulation results, is that a very small loss ˜3.3% in performance at the expense of saving (a relatively large amount of) ˜30% of the feedback overhead. Another technical effect is that the performance gap even decreases as the quantization resolution increases. A further technical effect is that the example embodiments may be implemented at the base station (for example, gNB 170) for improving spectral efficiency of the system for a given feedback rate and/or reducing the overall feedback overhead for NR MIMO and mMIMO systems.

An example embodiment may provide a method comprising determining a number of polarizations, determining a number of receive antennas that have a same polarization, determining a total number of receive antennas based on the number of polarizations and the number of receive antennas that have the same polarization; and applying singular value decomposition precoding on all the receive antennas with the same polarization.

In accordance with the example embodiments as described in the paragraphs above, receiving data via the receive antennas with the same polarization.

In accordance with the example embodiments as described in the paragraphs above, determining, for each polarization p=0 . . . P−1, a modified channel coefficient, \tilde{H}^{p}_{M×B}_{ₛ}_{.N}_{ᵣ} as a product of a modified matrix containing at least one spatial singular vector, a modified matrix containing at least one frequency singular vector and a modified diagonal matrix containing at least one singular value.

In accordance with the example embodiments as described in the paragraphs above, determining N=p×Nᵣ, where p is the number of polarizations, and Nᵣ is the number of receive antennas with the same polarization.

In accordance with the example embodiments as described in the paragraphs above, determining if an angular spread at a user equipment is below a predetermined threshold; and determining that there is a strong correlation of at least one amplitude of at least one received signal on the receive antennas which have the same polarization.

In accordance with the example embodiments as described in the paragraphs above, wherein a user equipment has omni directional antennas and at least one field pattern is equal to 1.

In accordance with the example embodiments as described in the paragraphs above, finding at least one channel matrix for all the receive antennas at the same time by applying

$${\tilde{H}}_{M \times {B}_{s} \cdot {N}_{T}}^{p} = {[ \begin{matrix}{c}_{1 + {pN}_{r}} ( 1 , 1 ) & & {c}_{{N}_{r} + {pN}_{r}} ( 1 , 1 ) & & {c}_{1 + {pN}_{r}} ( 1 , {B}_{s} ) & & {c}_{{N}_{r} + {pN}_{r}} ( 1 , {B}_{s} ) \\ ⋮ & … & & … & & … & ⋮ \\ {c}_{1 + {pN}_{r}} ( M , 1 ) & & {c}_{{N}_{r} + {pN}_{r}} ( M , 1 ) & & {c}_{1 + {pN}_{r}} ( M , {B}_{s} ) & & {c}_{{N}_{r} + {pN}_{r}} ( M , {B}_{s} )\end{matrix} ]}_{{B}_{s} \times M \cdot {N}_{r}} = {\tilde{U}}_{M \times d} {\tilde{Σ}}_{d \times d} {\tilde{V}}_{d \times {B}_{s} \cdot {N}_{r}}^{H} .$$

In accordance with the example embodiments as described in the paragraphs above, assuming one pilot subcarrier per physical resource block.

In accordance with the example embodiments as described in the paragraphs above, implementing a Multi-user, multiple-input, multiple-output scheme, where all user equipment's are spatially multiplexed on a same time-frequency resources.

An example embodiment may be provided in an apparatus comprising at least one processor; and at least one non-transitory memory including computer program code, the at least one memory and the computer program code may be configured to, with the at least one processor, cause the apparatus to: determine a number of polarizations; determine a number of receive antennas that have a same polarization; determine a total number of receive antennas based on the number of polarizations and the number of receive antennas that have the same polarization; and apply singular value decomposition precoding on all the receive antennas with the same polarization.

In accordance with the example embodiments as described in the paragraphs above, receive data via the receive antennas with the same polarization.

In accordance with the example embodiments as described in the paragraphs above, determine for each polarization p=0 . . . P−1, a modified channel coefficient, \tilde{H}^{p}_{M×B}_{ₛ}_{.N}_{ᵣ} as a product of a modified matrix containing at least one spatial singular vector, a modified matrix containing at least one frequency singular vector and a modified diagonal matrix containing at least one singular value.

In accordance with the example embodiments as described in the paragraphs above, determine N=p×Nᵣ, where p is the number of polarizations, and Nᵣ is the number of receive antennas with the same polarization.

In accordance with the example embodiments as described in the paragraphs above, determine if an angular spread at a user equipment is below a predetermined threshold; and determine that there is a strong correlation of at least one amplitude of at least one received signal on the receive antennas which have the same polarization.

In accordance with the example embodiments as described in the paragraphs above, wherein the apparatus has omni directional antennas and at least one field pattern is equal to 1.

In accordance with the example embodiments as described in the paragraphs above, find at least one channel matrix for all the receive antennas at the same time by applying

$${\tilde{H}}_{M \times {B}_{s} \cdot {N}_{T}}^{p} = {[ \begin{matrix}{c}_{1 + {pN}_{r}} ( 1 , 1 ) & & {c}_{{N}_{r} + {pN}_{r}} ( 1 , 1 ) & & {c}_{1 + {pN}_{r}} ( 1 , {B}_{s} ) & & {c}_{{N}_{r} + {pN}_{r}} ( 1 , {B}_{s} ) \\ ⋮ & … & & … & & … & ⋮ \\ {c}_{1 + {pN}_{r}} ( M , 1 ) & & {c}_{{N}_{r} + {pN}_{r}} ( M , 1 ) & & {c}_{1 + {pN}_{r}} ( M , {B}_{s} ) & & {c}_{{N}_{r} + {pN}_{r}} ( M , {B}_{s} )\end{matrix} ]}_{{B}_{s} \times M \cdot {N}_{r}} = {\tilde{U}}_{M \times d} {\tilde{Σ}}_{d \times d} {\tilde{V}}_{d \times {B}_{s} \cdot {N}_{r}}^{H} .$$

In accordance with the example embodiments as described in the paragraphs above, assume one pilot subcarrier per physical resource block.

In accordance with the example embodiments as described in the paragraphs above, implement a Multi-user, multiple-input, multiple-output scheme, where all user equipment's are spatially multiplexed on a same time-frequency resources.

An example embodiment may be provided in an apparatus comprising means for determining a number of polarizations, means for determining a number of receive antennas that have a same polarization, means for determining a total number of receive antennas based on the number of polarizations and the number of receive antennas that have the same polarization; and means for applying singular value decomposition precoding on all the receive antennas with the same polarization.

In accordance with the example embodiments as described in the paragraphs above, means for receiving data via the receive antennas with the same polarization.

In accordance with the example embodiments as described in the paragraphs above, determining for each polarization p=0 . . . P−1, a modified channel coefficient, \tilde{H}^{p}_{M×B}_{ₛ}_{.N}_{ᵣ} as a product of a modified matrix containing at least one spatial singular vector, a modified matrix containing at least one frequency singular vector and a modified diagonal matrix containing at least one singular value.

In accordance with the example embodiments as described in the paragraphs above, determining N=p×Nᵣ, where p is the number of polarizations, and Nᵣ is the number of receive antennas with the same polarization.

In accordance with the example embodiments as described in the paragraphs above, determining if an angular spread at a user equipment is below a predetermined threshold; and determine that there is a strong correlation of at least one amplitude of at least one received signal on the receive antennas which have the same polarization.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes example embodiments, these descriptions should not be viewed in a limiting sense. Rather, there are several variations and modifications which may be made without departing from the scope of the present invention.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications which may be made without departing from the scope of the present invention as defined in the appended claims.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of example and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method, comprising:
determining a number of polarizations;
determining a number of receive antennas that have a same polarization;
determining a total number of receive antennas based on the number of polarizations and the number of receive antennas that have the same polarization; and
applying singular value decomposition precoding on all the receive antennas with the same polarization.

2. The method of claim 1, further comprising:
receiving data via the receive antennas with the same polarization.

3. The method of claim 1, further comprising:
determining, for each polarization p=0 . . . P−1, a modified channel coefficient, \tilde{H}^{p}_{M×D}_{ₛ}_{N}_{ᵣ} as a product of a modified matrix containing at least one spatial singular vector, a modified matrix containing at least one frequency singular vector and a modified diagonal matrix containing at least one singular value.

4. The method of claim 1, wherein determining the total number of receive antennas further comprises:
determining N=p×Nᵣ, where p is the number of polarizations, and Nᵣ is the number of receive antennas with the same polarization.

5. The method of claim 1, wherein determining that the number of receive antennas have the same polarization further comprises:
determining if an angular spread at a user equipment is below a predetermined threshold; and
determining that there is a strong correlation of at least one amplitude of at least one received signal on the receive antennas which have the same polarization.

6. The method of claim 1, wherein a user equipment has omni directional antennas and at least one field pattern is equal to 1.

7. The method of claim 1, further comprising:
finding at least one channel matrix for all the receive antennas at the same time by applying
$${\tilde{H}}_{M \times {B}_{s} \cdot {N}_{T}}^{p} = {[ \begin{matrix}{c}_{1 + {pN}_{r}} ( 1 , 1 ) & & {c}_{{N}_{r} + {pN}_{r}} ( 1 , 1 ) & & {c}_{1 + {pN}_{r}} ( 1 , {B}_{s} ) & & {c}_{{N}_{r} + {pN}_{r}} ( 1 , {B}_{s} ) \\ ⋮ & … & & … & & … & ⋮ \\ {c}_{1 + {pN}_{r}} ( M , 1 ) & & {c}_{{N}_{r} + {pN}_{r}} ( M , 1 ) & & {c}_{1 + {pN}_{r}} ( M , {B}_{s} ) & & {c}_{{N}_{r} + {pN}_{r}} ( M , {B}_{s} )\end{matrix} ]}_{{B}_{s} \times M \cdot {N}_{r}} = {\tilde{U}}_{M \times d} {\tilde{Σ}}_{d \times d} {\tilde{V}}_{d \times {B}_{s} \cdot {N}_{r}}^{H} .$$

8. The method of claim 1, further comprising:
assuming one pilot subcarrier per physical resource block.

9. The method of claim 1, further comprising:
implementing a Multi-user, multiple-input, multiple-output scheme, where all user equipment's are spatially multiplexed on a same time-frequency resources.

10. An apparatus, comprising:
at least one processor; and
at least one non-transitory memory including computer program code,
the at least one non-transitory memory and the computer program code configured to, with the at least one processor, cause the apparatus to perform at least the following:
determine a number of polarizations;
determine a number of receive antennas that have a same polarization;
determine a total number of receive antennas based on the number of polarizations and the number of receive antennas that have the same polarization; and
apply singular value decomposition precoding on all the receive antennas with the same polarization.

11. The apparatus of claim 10, wherein the at least one non-transitory memory and the computer program code are further configured to, with the at least one processor, cause the apparatus to perform:
receive data via the receive antennas with the same polarization.

12. The apparatus of claim 10, wherein the at least one non-transitory memory and the computer program code are further configured to, with the at least one processor, cause the apparatus to perform:
determine for each polarization p=0 . . . P−1, a modified channel coefficient, \tilde{H}^{p}_{M×B}_{ₛ}_{.N}_{ᵣ} as a product of a modified matrix containing at least one spatial singular vector, a modified matrix containing at least one frequency singular vector and a modified diagonal matrix containing at least one singular value.

13. The apparatus of claim 10, wherein, when determining the total number of receive antennas, the at least one non-transitory memory and the computer program code are further configured to, with the at least one processor, cause the apparatus to perform:
determine N=p×Nᵣ, where p is the number of polarizations, and Nᵣ is the number of receive antennas with the same polarization.

14. The apparatus of claim 10, wherein, when determining that the number of receive antennas have the same polarization, the at least one non-transitory memory and the computer program code are further configured to, with the at least one processor, cause the apparatus to perform:
determine if an angular spread at a user equipment is below a predetermined threshold; and
determine that there is a strong correlation of at least one amplitude of at least one received signal on the receive antennas which have the same polarization.

15. The apparatus of claim 10, wherein the apparatus has omni directional antennas and at least one field pattern is equal to 1.

16. The apparatus of claim 10, wherein the at least one non-transitory memory and the computer program code are further configured to, with the at least one processor, cause the apparatus to perform:
find at least one channel matrix for all the receive antennas at the same time by applying
$${\tilde{H}}_{M \times {B}_{s} \cdot {N}_{T}}^{p} = {[ \begin{matrix}{c}_{1 + {pN}_{r}} ( 1 , 1 ) & & {c}_{{N}_{r} + {pN}_{r}} ( 1 , 1 ) & & {c}_{1 + {pN}_{r}} ( 1 , {B}_{s} ) & & {c}_{{N}_{r} + {pN}_{r}} ( 1 , {B}_{s} ) \\ ⋮ & … & & … & & … & ⋮ \\ {c}_{1 + {pN}_{r}} ( M , 1 ) & & {c}_{{N}_{r} + {pN}_{r}} ( M , 1 ) & & {c}_{1 + {pN}_{r}} ( M , {B}_{s} ) & & {c}_{{N}_{r} + {pN}_{r}} ( M , {B}_{s} )\end{matrix} ]}_{{B}_{s} \times M \cdot {N}_{r}} = {\tilde{U}}_{M \times d} {\tilde{Σ}}_{d \times d} {\tilde{V}}_{d \times {B}_{s} \cdot {N}_{r}}^{H} .$$

17. The apparatus of claim 10, wherein the at least one non-transitory memory and the computer program code are further configured to, with the at least one processor, cause the apparatus to perform:
assume one pilot subcarrier per physical resource block.

18. The apparatus of claim 10, wherein the at least one non-transitory memory and the computer program code are further configured to, with the at least one processor, cause the apparatus to perform:
implement a Multi-user, multiple-input, multiple-output scheme, where all user equipment's are spatially multiplexed on a same time-frequency resources.

19. A non-transitory program storage device readable by a machine, tangibly embodying a program of instructions executable by the machine for performing operations, the operations comprising:
determining a number of polarizations;
determining a number of receive antennas that have a same polarization;
determining a total number of receive antennas based on the number of polarizations and the number of receive antennas that have the same polarization; and
applying singular value decomposition precoding on all the receive antennas with the same polarization.

20. The non-transitory program storage device of claim 19, the operations further comprising:
receiving data via the receive antennas with the same polarization.
